(19) United States
(12) Patent Application Publication
(10) Pub. No.: US 2004/0141902 A1
(43) Pub. Date: Jul. 22, 2004

(54) Process and apparatus for producing a krypton/xenon mixture from air

(76) Inventor: Francois Fuentes, Le Vesinet (FR)

Correspondence Address: Linda K. Russell, Air Liquide, Suite 1800, 2700 Post Oak Blvd., Houston, TX, 77056, US

(21) Appl. No.: 10/717,811

(22) Filed: Nov. 20, 2003

(30) Foreign Application Priority Data
Nov. 25, 2002 (FR) 02 14742

(51) Int. Cl. B01J 8/00; C01B 23/00

(52) U.S. Cl. 423/262; 423/650; 422/187; 422/188

(57) ABSTRACT

According to this process:

(a) air is distilled in at least one air distillation apparatus (8) so as to produce a stream of liquid oxygen containing most of the krypton and xenon from the air, and this stream of liquid oxygen is vaporized;

(b) a partial oxidation of at least one hydrocarbon is carried out with at least one portion of the gaseous oxygen obtained in step (a), so as to produce a syngas containing at most 0.1 ppm mol of oxygen; and

(c) constituents other than krypton and xenon are removed from the syngas.

The present invention relates to a process and a plant for producing a krypton/xenon mixture from air.

The main source of krypton and xenon is the atmosphere, in which they are present in trace amounts, namely 1.135 ppm and 0.086 ppm (ppm: parts per million) respectively.

The purification method normally used consists in extracting an enriched mixture from a cryogenic air separation apparatus, typically at the liquid oxygen reboiler, then in concentrating this mixture by cryogenic distillation. Krypton+xenon contents of around 99% are thus obtained. This mixture is then separated into krypton and xenon, generally in a laboratory.

A major problem posed by this method concerns safety. This is because, owing to their boiling points, krypton and xenon, which are heavy rare gases, are essentially found in liquid oxygen at the same time as the hydrocarbons present in trace amounts in the air. Enrichment in a single step therefore runs the risk of leading to a hydrocarbon/oxygen ratio of explosive nature.

It is therefore necessary to carry out a first partial enrichment by distillation followed by the removal of the hydrocarbons, this being accomplished chemically at a non-cryogenic temperature, and then a new cryogenic distillation is carried out. In addition, since the chemical reaction creates compounds (especially CO₂ or H₂O) that may solidify at the distillation temperatures of the mixture, it is necessary to interpose an adsorption (or equivalent) step downstream of the reactor for removing the hydrocarbons.

It may also be noted that the size of the krypton/xenon purification equipment is substantial owing to the low content of these constituents in liquid oxygen (a few ppm to a few tens of ppm).

The object of the invention is to provide a process for producing krypton/xenon from air that is safe and requires equipment relatively small in size.

For this purpose, the subject of the invention is a process for producing a krypton/xenon mixture from air, characterized in that:

(a) air is distilled in at least one air distillation apparatus so as to produce a stream of liquid oxygen containing most of the krypton and xenon from the air, and this stream of liquid oxygen is vaporized;

(b) a partial oxidation of at least one hydrocarbon is carried out with at least one portion of the gaseous oxygen obtained in step (a), so as to produce a syngas containing less than 0.1 ppm mol of oxygen; and

(c) constituents other than krypton and xenon are removed from the syngas.

The process according to the invention may include one or more of the following features:

the partial oxidation is carried out by reacting the oxygen with an excess of hydrocarbon(s) and optionally with steam;

the partial oxidation is carried out by reacting the oxygen with natural gas, methane, naphtha or coal;

step (c) includes a dessication/decarbonation step followed by a cryogenic separation;

the cryogenic separation comprises a series of steps that produce a krypton/xenon-enriched stream furthermore containing essentially methane and carbon monoxide, a hydrogen stream, a carbon monoxide stream and a waste stream;

the said series of steps comprises a step of sending liquid carbon monoxide into the top of a first column, an expansion of the bottom liquid from this column, the removal of the hydrogen from a second column that is fed at the top with the said expanded bottom liquid, an expansion of the bottom liquid from the second column and the injection of this expanded liquid into a low-pressure column fed at the top with liquid carbon monoxide and producing, as tops, carbon monoxide and, as bottoms, the said krypton/xenon-enriched stream; and

the cryogenic separation furthermore includes, optionally after intermediate warming of the krypton/xenon-enriched stream, a cryogenic separation, on the one hand, of the krypton and xenon from, on the other hand, the other constituents of this stream.

Another object of the invention is to provide a plant for producing a krypton/xenon mixture from air, characterized in that it comprises:

an air distillation apparatus that produces a liquid oxygen stream containing most of the krypton and xenon from the air, this apparatus being combined with a reboiler for vaporizing this liquid oxygen stream;

a partial oxidation reactor fed, on the one hand, with the vaporized oxygen stream and, on the other hand, with a gas that contains at least one hydrocarbon, this reactor producing a syngas containing at most 0.1 ppm mol of oxygen; and

means (3 to 7) for removing constituents other than krypton and xenon from the syngas.

According to other optional aspects:

the said removal means comprise dessication/decarbonation means followed by a cryogenic separation unit;

the cryogenic separation unit comprises a combination of columns suitable for producing a krypton/xenon-enriched stream furthermore containing essentially methane and carbon monoxide, a hydrogen stream, a carbon monoxide stream and a waste stream;

the cryogenic separation unit comprises a first column, means for sending liquid carbon monoxide into the top of the first column, means for expanding the bottom liquid from this first column, a second column for removing hydrogen, the said second column being fed at the top with the said expanded bottom liquid, means for expanding the bottom liquid from the said second column, and a low-pressure column fed at an intermediate level with the expanded bottom liquid from the second column and at the top with liquid carbon monoxide, this low-pressure column producing, as tops, carbon monoxide and, as bottoms, the said krypton/xenon-enriched stream; and

the cryogenic separation unit furthermore includes a column for separating, on the one hand, krypton and xenon from, on the other hand, the other constituents of this stream.

Examples of implementation of the invention will now be described with regard to the appended drawings, in which:

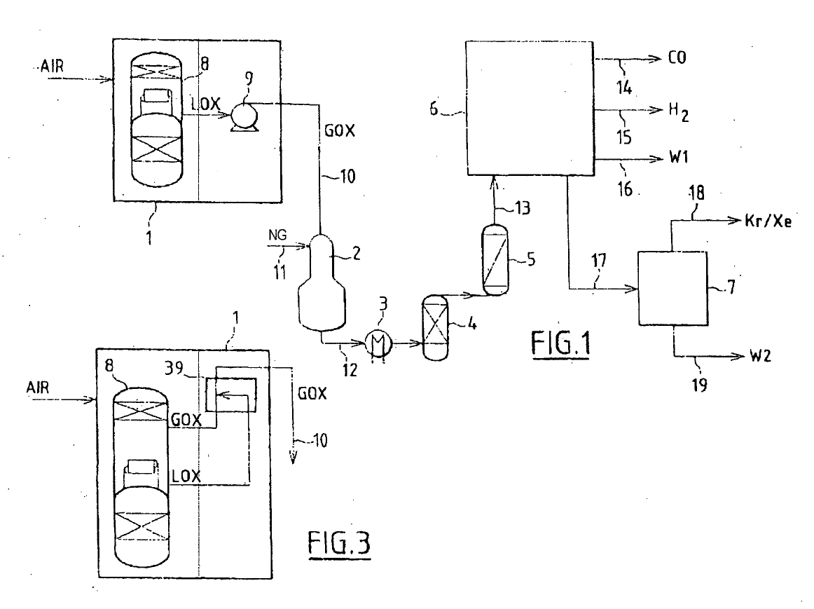

FIG. 1 is an overall diagram of a plant according to the invention;

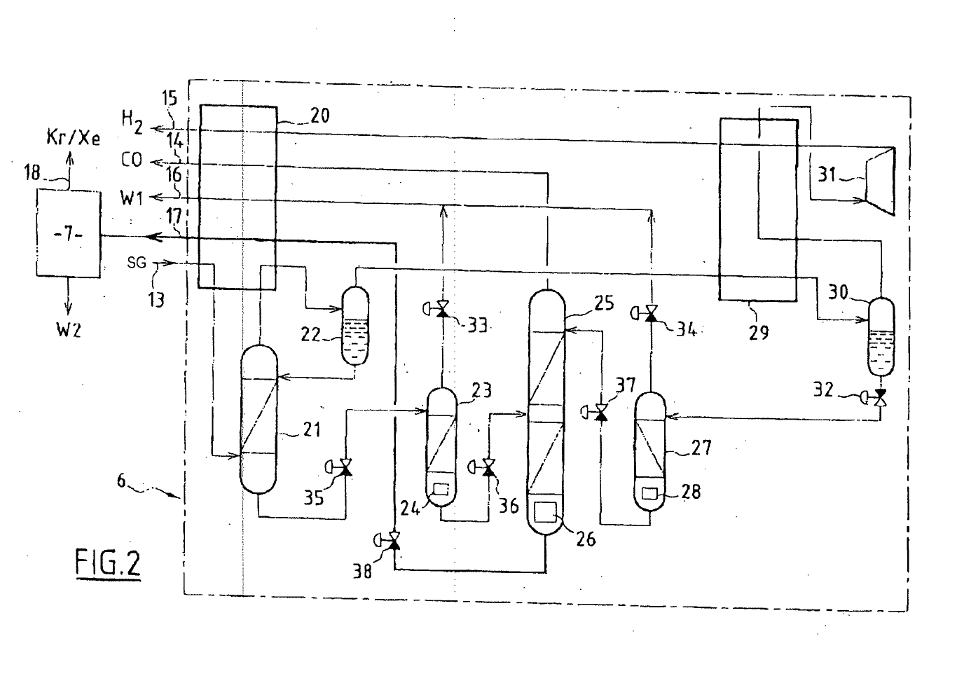

FIG. 2 shows schematically a portion of this plant; and

FIG. 3 is a partial diagram of a variant.

The plant shown in FIG. 1 comprises a cold box 1 containing a double-column air distillation apparatus, a partial oxidation reactor 2, a condenser 3, an amine-scrubbing decarbonation apparatus 4, an adsorption-type dessication-decarbonation apparatus 5, a cold box 6 for producing carbon monoxide CO, hydrogen, a first waste stream W1 and a krypton/xenon-rich mixture, and a cold box 7 for separating, on the one hand, the krypton/xenon from, on the other hand, a second waste stream W2.

In operation, the atmospheric air, precompressed and purified of water and of CO₂, is cooled in the cold box 1 and distilled in the double distillation column 8 contained in the latter, which is of conventional structure, namely a medium-pressure column and a low-pressure column coupled via a reboiler-condenser. Liquid oxygen LOX, withdrawn from the bottom of the low-pressure column, is pumped by a cryogenic pump 9 to a high pressure, typically 20 bar, and is vaporized at this high pressure in order to form a gaseous oxygen stream GOX, which contains substantially all the krypton and xenon that were contained in the incoming air. The liquid oxygen generally vaporizes in the main exchanger of the air separation unit (ASU) or in a dedicated exchanger by heat exchange with a flow of pressurized air or nitrogen.

This oxygen is fed via a line 10 to the reactor 2, which also receives natural gas (typically 98% CH₄/2% N₂), in excess, via a line 11. Optionally, steam participates in the reaction if the partial oxidation is of the ATR (autothermal reforming) type.

The oxygen may come from several ASUs.

Thus a syngas containing less than 0.1 ppm mol of oxygen is produced via a line 12, which syngas, after cooling at 3, is stripped of its carbon dioxide CO₂ at 4 and of its water and of traces of its carbon dioxide CO₂ at 5.

Thus, it is a mixture of hydrogen, CO, unreacted methane containing krypton/xenon and essentially traces of nitrogen and argon that enters the cold box 6 via a line 13.

Output from the cold box 6 are the CO via a line 14, the hydrogen via a line 15, the waste W1, essentially consisting of CO and hydrogen, via a line 16, and the krypton/xenon-rich mixture via a line 17.

The cold box 7, fed via the line 17, essentially contains a distillation column which produces, as tops, via a line 18, the krypton/xenon mixture and, as bottoms, via a line 19, the waste gas W2, essentially consisting of methane, CO, nitrogen and argon.

As shown in FIG. 2, the cold box 6 essentially comprises:

a main heat exchanger 20 of the countercurrent type;

a high-pressure column 21 for CO-scrubbing, provided above it with a phase separator 22;

an intermediate-pressure flash column 23 provided with a bottom reboiler 24;

a low-pressure column 25 provided with a bottom reboiler 26;

an intermediate-pressure flash column 27 provided with a bottom reboiler 28;

a secondary heat exchanger 29;

a high-pressure phase separator 30; and

an expansion turbine 31.

In operation, the syngas conveyed via the line 13, cooled in the warm part of the exchanger 20, is introduced into the bottom of the column 21. The light constituents, essentially hydrogen and carbon monoxide that are produced as tops of this column, are cooled and partially condensed in the cold part of the exchanger 20 and then introduced into the phase separator 22. The bottom liquid from this separator, essentially consisting of CO, is sent in reflux mode to the top of the column 21, while the vapour phase, cooled again and partially condensed from the hot end to the cold end of the exchanger 29, is introduced into the phase separator 30. The latter produces high-pressure hydrogen as tops and high-pressure CO as bottoms.

The high-pressure hydrogen, warmed in the exchanger 29, is expanded down to near atmospheric pressure in the turbine 31 and then warmed by passing through the exchanger 29 and then the exchanger 20, thereby keeping the cold box 6 cold. This stream is then recovered via the line 15.

The liquid CO collected in the separator 30, and containing traces of hydrogen, is expanded to an intermediate pressure in an expansion valve 32 and introduced into the top of the column 27. This column produces an H₂/CO mixture as tops and liquid CO as bottoms.

The bottom liquid from the column 21, essentially consisting of methane and CO and containing krypton/xenon and traces of hydrogen, is expanded to an intermediate pressure in an expansion valve 35 and introduced into the top of the column 23. An H₂/CO mixture is withdrawn from the top of this column.

The H₂/CO streams coming from the columns 23 and 27, after being expanded down to near atmospheric pressure in respective expansion valves 33 and 34, come together in the same line in order to form the waste gas W1, which is warmed in 20 and discharged via the line 16.

The bottom liquid from the column 23 is again expanded, to low pressure, in an expansion valve 36 and then introduced at an intermediate level into the column 25. The liquid CO withdrawn from the bottom of the column 27 is expanded to the low pressure in an expansion valve 37 and introduced into the top of the column 25. Thus, this column separates, on the one hand, the CO withdrawn from the top and then warmed at 20 and recovered via the line 14 and, on the other hand, a methane/CO mixture containing krypton/xenon and traces of nitrogen and argon.

This mixture, optionally after being expanded down to near atmospheric pressure in an expansion valve 38, is warmed in 20, then recovered via the line 17 before being treated in the cold box 7, as described above.

As will be understood, many alternative embodiments may be envisaged. For example, the bottom reboilers 24, 26 and 28 may be heated by means of any suitable stream available at a suitable pressure in the unit, for example by means of syngas. Likewise, a carbon monoxide cycle may be used for keeping the columns 23, 25 and 27 cold and/or for the reboiling therein, as is known per se.

Moreover, the cold boxes 1, 6 and 7 may be combined to a greater or lesser extent as regards the way they are installed and/or kept cold. For example, if the cold boxes 6 and 7 are combined, the bottom liquid from the column 25 may be sent directly to the final column for separating off the krypton/xenon, without intermediate warming.

Thus, oxygen is produced according to the process described above, this being compressed so as to carry out a first concentration of the krypton/xenon from air. Next, a syngas containing no oxygen and having a low methane content, containing all the krypton/xenon, is produced, which then allows a small krypton/xenon enrichment unit to be used. Because there is no oxygen in the syngas, there is no risk of an explosion in this unit.

The two flash columns 23 and 27, at intermediate pressures, are used to remove the hydrogen dissolved in the carbon monoxide intended for the column 25.

It should be noted that this recovery of the krypton/xenon may be easily implemented in an existing hydrogen/carbon monoxide production unit. This unit may be based on a process for separating hydrogen from CO that is different from the one shown in FIG. 2, for example based on a “methane-scrubbing” process. However, the process of FIG. 2 is particularly suitable for recovering the krypton/xenon.

FIG. 3 illustrates an alternative embodiment of the cold box 1, in which the oxygen sent to the reactor 2 is formed partly from gaseous oxygen withdrawn from the bottom of the low-pressure column of the double column 8 and partly from liquid oxygen withdrawn from the bottom of the same column, vaporized in a heat exchanger 39 of the cold box 1 and merged with the stream of gaseous oxygen.

1. Process for producing a krypton/xenon mixture from air, characterized in that:
(a) air is distilled in at least one air distillation apparatus (8) so as to produce a stream of liquid oxygen containing most of the krypton and xenon from the air, and this stream of liquid oxygen is vaporized;
(b) a partial oxidation of at least one hydrocarbon is carried out with at least one portion of the gaseous oxygen obtained in step (a), so as to produce a syngas containing at most 0.1 ppm mol of oxygen; and
(c) constituents other than krypton and xenon are removed from the syngas.

2. Process according to claim 1, characterized in that the partial oxidation is carried out by reacting the oxygen with an excess of hydrocarbon(s) and optionally with steam.

3. Process according to claim 1 or 2, characterized in that the partial oxidation is carried out by reacting the oxygen with natural gas, methane, naphtha or coal.

4. Process according to any one of claims 1 to 3, characterized in that step (c) includes a dessication/decarbonation step followed by a cryogenic separation.

5. Process according to claim 4, characterized in that the cryogenic separation comprises a series of steps that produce a krypton/xenon-enriched stream furthermore containing essentially methane and carbon monoxide, a hydrogen stream, a carbon monoxide stream and a waste stream.

6. Process according to claim 5, characterized in that the said series of steps comprises a step of sending liquid carbon monoxide into the top of a first column (21), an expansion (at 35) of the bottom liquid from this column, the removal of the hydrogen from a second column (23) that is fed at the top with the said expanded bottom liquid, an expansion (at 36) of the bottom liquid from the second column (23) and the injection of this expanded liquid into a low-pressure column (25) fed at the top with liquid carbon monoxide and producing, as tops, carbon monoxide and, as bottoms, the said krypton/xenon-enriched stream.

7. Process according to claim 5 or 6, characterized in that the cryogenic separation furthermore includes, optionally after intermediate warming of the krypton/xenon-enriched stream, a cryogenic separation, on the one hand, of the krypton and xenon from, on the other hand, the other constituents of this stream.

8. Plant for producing a krypton/xenon mixture from air, characterized in that it comprises:
an air distillation apparatus (8) that produces a liquid oxygen stream containing most of the krypton and xenon from the air, this apparatus being combined with a reboiler for vaporizing this liquid oxygen stream;
a partial oxidation reactor (2) fed, on the one hand, with the vaporized oxygen stream and, on the other hand, with a gas that contains at least one hydrocarbon, this reactor producing a syngas containing at most 0.1 ppm mol of oxygen; and
means (3 to 7) for removing constituents other than krypton and xenon from the syngas.

9. Plant according to claim 8, characterized in that the said removal means (3 to 7) comprise dessication/decarbonation means (4, 5) followed by a cryogenic separation unit (6, 7).

10. Plant according to claim 9, characterized in that the cryogenic separation unit (6, 7) comprises a combination of columns (21, 23, 25, 27) suitable for producing a krypton/xenon-enriched stream furthermore containing essentially methane and carbon monoxide, a hydrogen stream, a carbon monoxide stream and a waste stream.

11. Plant according to claim 9 or 10, characterized in that the cryogenic separation unit (6, 7) comprises a first column (21), means for sending liquid carbon monoxide into the top of the first column, means (35) for expanding the bottom liquid from this first column, a second column (23) for removing hydrogen, the said second column being fed at the top with the said expanded bottom liquid, means (36) for expanding the bottom liquid from the said second column, and a low-pressure column (25) fed at an intermediate level with the expanded bottom liquid from the second column (23) and at the top with liquid carbon monoxide, this low-pressure column (25) producing, as tops, carbon monoxide and, as bottoms, the said krypton/xenon-enriched stream.

12. Plant according to claim 10 or 11, characterized in that the cryogenic separation unit (6, 7) furthermore includes a column for separating, on the one hand, the krypton and the xenon from, on the other hand, the other constituents of this stream.
